(19) United States
(12) Patent Application Publication
(10) Pub. No.: US 2007/0266205 A1
(43) Pub. Date: Nov. 15, 2007

(54) System and Method for Customization of Network Controller Behavior, Based on Application-Specific Inputs

(76) Inventors: John F. Bevilacqua, Hayward, CA (US); Paul Nehse, Livermore, CA (US)

Correspondence Address: DICKSTEIN SHAPIRO LLP, 1825 EYE STREET NW, Washington, DC, 20006-5403, US

(21) Appl. No.: 11/662,957

(22) PCT Filed: Sep. 22, 2005
(86) PCT No.: PCT/US05/34209

§ 371 Date: May 9, 2007

Related U.S. Application Data
(60) Provisional application No. 60/611,803, filed on Sep. 22, 2004.

(51) Int. Cl. G06F 12/00

(52) U.S. Cl. 711/114

(57) ABSTRACT

A system and method for providing application-specific configuration data for a network controller. A plurality of user-specific network requirements are generated. The plurality of user-specific network requirements are programmed into a reprogrammable memory located in the network controller. The network controller is powered-up. The plurality of user-specific network requirements are loaded onto a plurality of software applications running on the network controller.

### CROSS-REFERENCE TO RELATED APPLICATIONS

This application claims the benefit of U.S. Provisional Application Ser. No. 60/611,803, filed Sep. 22, 2004 in the U.S. Patent and Trademark Office, the entire content of which is incorporated by reference herein.

### FIELD OF THE INVENTION

The present invention relates to customizing the operating characteristics of redundant arrays of inexpensive disks (RAIDs) and, more specifically, to a system and method of customizing a RAID controller's behavior, based on application-specific inputs.

### BACKGROUND OF THE INVENTION

Currently, redundant arrays of inexpensive disk (RAID) systems are the principle storage architecture for large, networked computer storage systems. RAID architecture was first documented in 1987 when Patterson, Gibson, and Katz published a paper entitled, “A Case for Redundant Arrays of Inexpensive Disks (RAID)” (University of California, Berkeley). Fundamentally, RAID architecture combines multiple small, inexpensive disk drives into an array of disk drives that yields performance that exceeds that of a Single Large Expensive Drive (SLED). Additionally, this array of drives appears to the computer to be a single logical storage unit (LSU) or drive. Five types of array architectures, designated as RAID-1 through RAID-5, were defined by the Berkeley paper, each providing disk fault-tolerance and each offering different trade-offs in features and performance. In addition to these five redundant array architectures, a non-redundant array of disk drives is referred to as a RAID-0 array. RAID controllers provide data integrity through redundant data mechanisms, high speed through streamlined algorithms, and accessibility to the data for users and administrators.

A networking technique that is fundamental to the various RAID levels is “striping,” a method of concatenating multiple drives into one logical storage unit. Striping involves partitioning each drive's storage space into stripes, which may be as small as one sector (512 bytes) or as large as several megabytes. These stripes are then interleaved round-robin, so that the combined space is composed alternately of stripes from each drive. In effect, the storage space of the drives is shuffled like a deck of cards. The type of application environment, I/O or data intensive, determines whether large or small stripes should be used. The choice of stripe size is application dependant and affects the real-time performance of data acquisition and storage in mass storage networks. In data intensive environments and single-user systems which access large records, small stripes (typically one 512-byte sector in length) can be used so that each record will span across all the drives in the array) each drive storing part of the data from the record. This causes long record accesses to be performed faster, because the data transfer occurs in parallel on multiple drives. Applications such as on-demand video/audio, medical imaging, and data acquisition, which utilize long record accesses, will achieve optimum performance with small stripe arrays.

In addition to stripe size, a number of other parameters also affect the real-time performance of mass storage networks. For, example database applications require optimized data integrity and, therefore, offer robust error handling policies and drive redundancy strategies, such as data mirroring. Real-time video applications require high throughput and dynamic caching of data, but are less optimized with regard to data integrity. Consequently, most memory networks are customized or “tuned” to their specific application. The operation of most standard RAID controllers is set at the Application Programming Interface (API) level. Typically, Original Equipment Manufacturers (OEMs) bundle RAID networks and sell these memory systems to end users for network storage. OEMs bear the burden of customization of a RAID network and tune the network performance through an API. However, the degree to which a RAID system can be optimized through the API is limited. The API does not adequately handle the unique performance requirements of various dissimilar data storage applications. Additionally, the API does not provide an easily modifiable and secure format for proprietary OEM RAID configurations.

What is needed is a method of configuring a RAID to a set of unique configurations, such that the RAID network is factory-ready for a specific application. What is further needed is a way for RAID configurations to be performed that will enable an OEM to develop proprietary configurations of optimized RAID networks in such a way that the OEMs are able to distinguish themselves in the marketplace.

An example of an invention for a tunable device controller for RAID is U.S. Patent Application Publication No. 2002/0095532, entitled, “System, Method, and Computer Program for Explicitly Tunable I/O Device Controller.” The '532 application describes a structure, method, and computer program for an explicitly tunable device controller, such as a RAID controller, for example. The invention provides a means of matching a controller's configuration with a specific data type. In one embodiment, the controller configuration is adjusted automatically and dynamically during normal I/O operations to suit the particular input/output needs of an application. Configuration information may be selected, for example, from such parameters as data redundancy level, RAID level, number of drives in a RAID array, memory module size, cache line size, direct I/O or cached I/O mode, read-ahead cache enable or read-ahead cache disable, cache line aging, cache size, or any combination of these parameters.

While the '532 application provides a means of dynamically tuning a RAID controller to a particular application, the invention does not provide a means for factory-ready programmability and, therefore, it lacks a secure data format to enable an OEM to develop proprietary configurations of optimized RAID networks. As a result, the '532 application does not ensure that the unique value-added RAID controller configurations developed by OEMs can be maintained as a distinguisher in the marketplace.

It is therefore an object of the invention to configure a RAID to a set of unique configurations, such that the RAID network is factory-ready for a specific application.

It is another object of this invention to enable an OEM to tune to develop proprietary configurations of optimized RAID networks in such a way that they are able to distinguish themselves in the marketplace.

### BRIEF SUMMARY OF THE INVENTION

The present invention provides a method for providing application-specific configuration data for a network controller. The method includes a step of generating a plurality of user-specific network requirements. The plurality of user-specific network requirements are programmed into a reprogrammable memory located in the network controller. The network controller is powered-up. The plurality of user-specific network requirements are loaded onto a plurality of software applications running on the network controller.

The present invention also provides a system for providing application specific configuration data for a network controller. The system includes a network controller, a reprogrammable memory and a plurality of software applications. The reprogrammable memory is located in the network controller and is configured to store a plurality of user-specific network requirements. The plurality of software applications run on the network controller. The plurality of user-specific network requirements may be loaded onto the plurality of software applications.

These and other aspects of the invention will be more clearly recognized from the following detailed description of the invention which is provided in connection with the accompanying drawings.

### BRIEF DESCRIPTION OF THE DRAWINGS

FIG. 1 illustrates a block diagram of a conventional RAID networked storage system in accordance with an embodiment of the invention.

FIG. 2 illustrates a block diagram of a RAID controller system in accordance with an embodiment of the invention.

FIG. 3 illustrates a block diagram of RAID controller hardware for use with an embodiment of the invention.

FIG. 4 illustrates a block diagram that further details system manager 228 for use with an embodiment of the invention.

FIG. 5 illustrates a flow diagram of a method of initializing RAID controllers that have unique personality data in accordance with an embodiment of the invention.

### DETAILED DESCRIPTION OF THE INVENTION

The present invention is a system and method for providing application-specific configuration data for a RAID controller, such that the RAID network is optimized by the OEM for its intended application. The method of the present invention includes the steps of generating requirements, creating an XML file, programming flash, powering up the system, loading XML data and accepting commands. The configuration data are then applied to the RAID system and the controller is ready to accept commands from the RAID host.

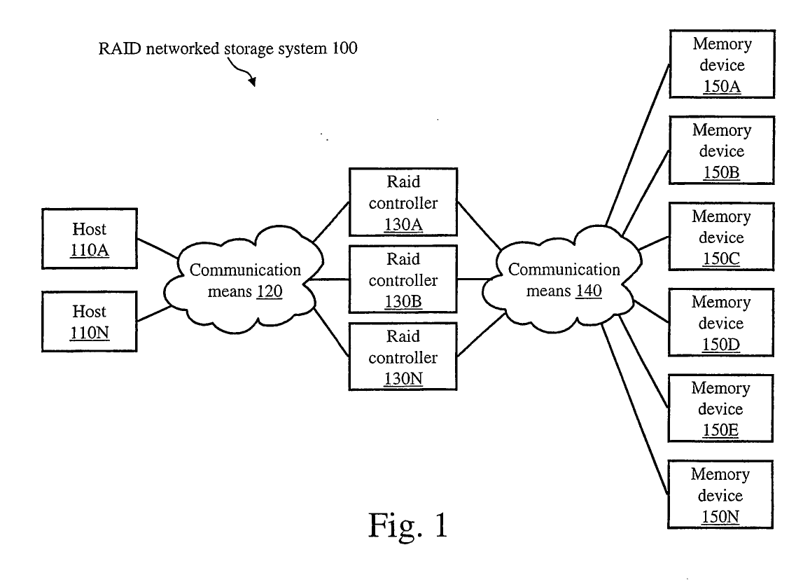

FIG. 1 is a block diagram of a conventional RAID networked storage system 100 that combines multiple small, inexpensive disk drives into an array of disk drives that yields superior performance characteristics, such as redundancy, flexibility, and economical storage. Conventional RAID networked storage system 100 includes a plurality of hosts 110A through 110N, where ‘N’ is not representative of any other value ‘N’ described herein. Hosts 110 are connected to a communications means 120, which is further coupled via host ports (not shown) to a plurality of RAID controllers 130A and 130B through 130N, where ‘N’ is not representative of any other value ‘N’ described herein. RAID controllers 130 are connected through device ports (not shown) to a second communication means 140, which is further coupled to a plurality of memory devices 150A through 150N, where ‘N’ is not representative of any other value ‘N’ described herein. Memory devices 150 are housed within enclosures (not shown).

Hosts 110 are representative of any computer systems or terminals that are capable of communicating over a network. Communication means 120 is representative of any type of electronic network that uses a protocol, such as Ethernet. RAID controllers 130 are representative of any storage controller devices that process commands from hosts 110 and, based on those commands, control memory devices 150. RAID controllers 130 also provide data redundancy, based on system administrator programmed RAID levels. This includes data mirroring, parity generation, and/or data regeneration from parity after a device failure. Physical to logical and logical to physical mapping of data is also an important function of the controller that is related to the RAID level in use. Communication means 140 is any type of storage controller network, such as iSCSI or fibre channel. Memory devices 150 may be any type of storage device, such as, for example, tape drives, disk drives, non-volatile memory, or solid state devices. Although most RAID architectures use disk drives as the main storage devices, it should be clear to one skilled in the art that the invention embodiments described herein apply to any type of memory device.

In operation, host 110A, for example, generates a read or a write request for a specific volume, (e.g., volume 1), to which it has been assigned access rights. The request is sent through communication means 120 to the host ports of RAID controllers 130. The command is stored in local cache in, for example, RAID controller 130B, because RAID controller 130B is programmed to respond to any commands that request volume 1 access. RAID controller 130B processes the request from host 110A and determines the first physical memory device 150 address from which to read data or to write new data. If volume 1 is a RAID 5 volume and the command is a write request, RAID controller 130B generates new parity, stores the new parity to the parity memory device 150 via communication means 140, sends a “done” signal to host 110A via communication means 120, and writes the new host 110A data through communication means 140 to the corresponding memory devices 150.

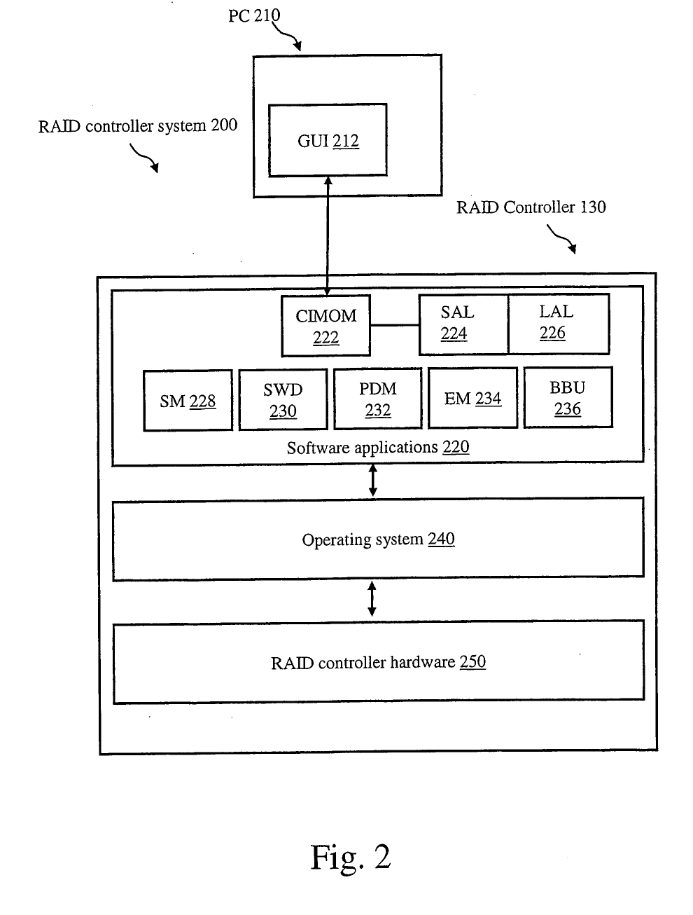

FIG. 2 is a block diagram of a RAID controller system 200. RAID controller system 200 includes RAID controllers 130 and a general purpose personal computer (PC) 210. PC 210 further includes a graphical user interface (GUI) 212. RAID controllers 130 further include software applications 220, an operating system 240, and a RAID controller hardware 250. Software applications 220 further include a common information module object manager (CIMOM) 222, a software application layer (SAL) 224, a logic library layer (LAL) 226, a system manager (SM) 228, a software watchdog (SWD) 230, a persistent data manager (PDM) 232, an event manager (EM) 234, and a battery backup (BBU) 236.

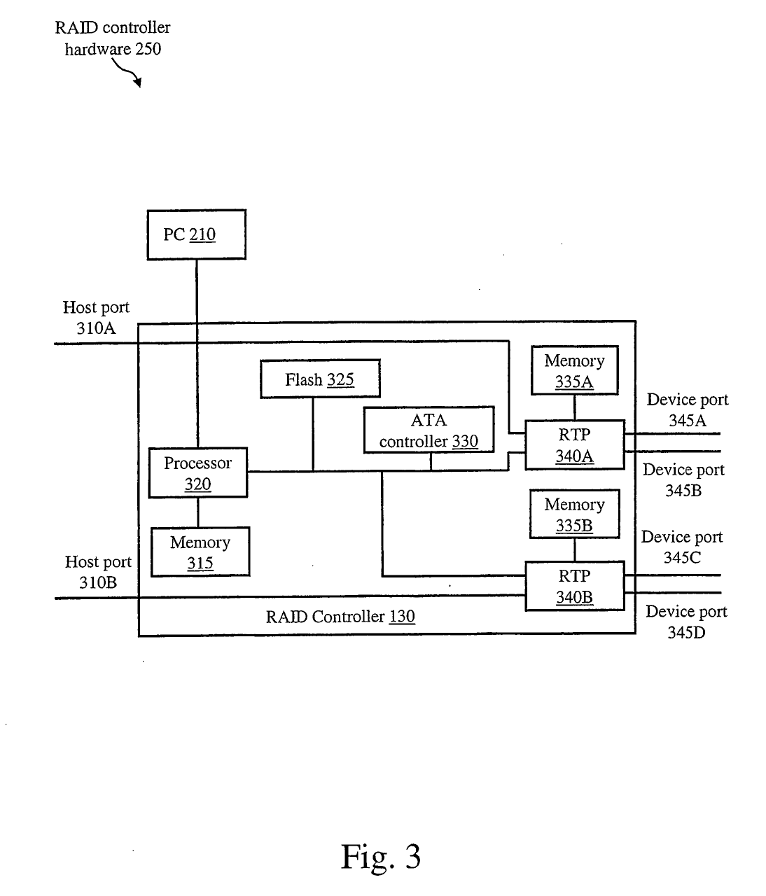

GUI 212 is a software application used to input personality attributes for RAID controllers 130. GUI 212 runs on PC 210. RAID controllers 130 are representative of RAID storage controller devices that process commands from hosts 110 and, based on those commands, control memory devices 150. As shown in FIG. 2, RAID controllers 130 are an exemplary embodiment of the invention; however, other implementations of controllers may be envisioned here by those skilled in the art. RAID controllers 130 provide data redundancy, based on system-administrator-programmed RAID levels. This includes data mirroring, parity generation, and/or data regeneration from parity after a device failure. RAID controller hardware 250 is the physical processor platform of RAID controllers 130 that executes all RAID controller software applications 220 and consists of a microprocessor, memory, and all other electronic devices necessary for RAID control, as described, in detail, in the discussion of FIG. 3. Operating system 240 is an industry-standard software platform, such as Linux, for example, upon which software applications 220 can run. Operating system 240 delivers other benefits to RAID controllers 130. Operating system 240 contains utilities, such as a file system, that provide a way for RAID controllers 130 to store and transfer files. Software applications 220 contain algorithms and logic necessary for the RAID controllers 130 and are divided into those needed for initialization and those that operate at run-time. Initialization software applications 220 consists of the following software functional blocks: CIMOM 222, which is a module that instantiates all objects in software applications 220 with the personality attributes entered, SAL 224, which is the application layer upon which the run-time modules execute, and LAL 226, a library of low-level hardware commands used by a RAID transaction processor, as described in the discussion of FIG. 3.

Software applications 220 that operate at run-time consist of the following software functional blocks: system manager 228, a module that carries out the run-time executive; SWD 230, a module that provides software supervision function for fault management; PDM 232, a module that handles the personality data within software applications 220; EM 234, a task scheduler that launches software applications 220 under conditional execution; and BBU 236, a module that handles power bus management for battery backup.

FIG. 3 is a block diagram of RAID controller hardware 250. RAID controller hardware 250 is the physical processor platform of RAID controller system 200 and includes a general purpose personal computer (PC) 210 and RAID controller 130. RAID controller 130 is the platform that executes all RAID controller software applications 220 and consists of host ports 310A and 310B, memory 315, a processor 320, a flash 325, an ATA controller 330, memory 335A and 335B, RAID transaction processors (RTP) 340A and 340B, and device ports 345A through D.

Host ports 310 are the input for a host communication channel, such as an iSCSI or a fibre channel.

Processor 320 is a general purpose micro-processor that executes software applications 220 that run under operating system 240.

Memory 315 is volatile processor memory, such as synchronous DRAM.

Flash 325 is a physically removable, non-volatile storage means, such as an EEPROM. Flash 325 stores the personality attributes for RAID controllers 130.

ATA controller 330 provides low level disk controller protocol for Advanced Technology Attachment protocol memory devices.

RTP 340 provides RAID controller functions on an integrated circuit and uses memory 335A and 335B for cache.

Memory 335A and 335B are volatile memory, such as synchronous DRAM.

Device ports 345 are memory storage communication channels, such as iSCSI or fibre channels.

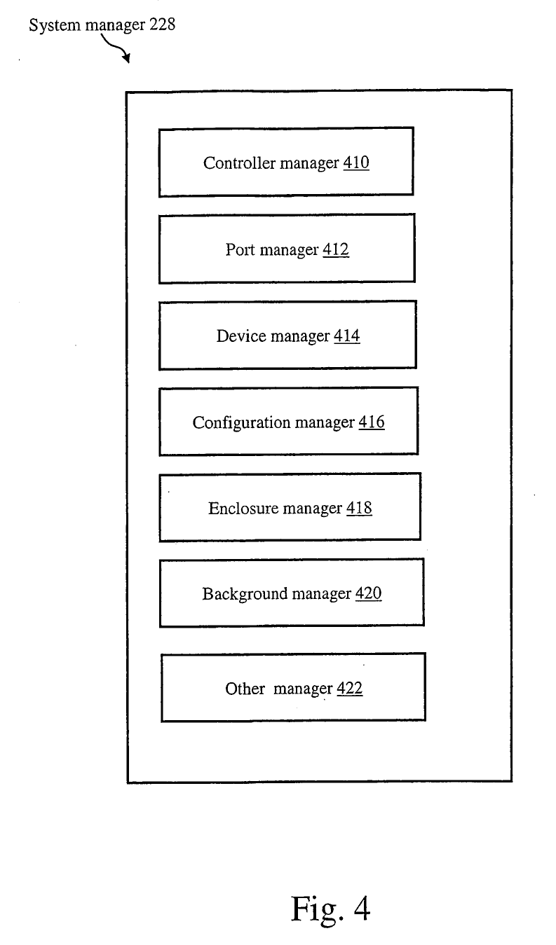

FIG. 4 is a block diagram that further details system manager 228 within software applications 220. System manager 228 is composed of a controller manager 410, a port manager 412, a device manager 414, a configuration manager 416, an enclosure manager 418, a background manager 420, and an other manager 422.

System manager 228 is formed of the following configurable software constructs that have unique responsibilities for handling data within RAID controllers 130:

Controller manager 410 is a software module that directs caching, implements statistics gathering, and handles error policies, such as loss of power or loss of components, for example.

Port manager 412 is a software module responsible for fiber port configuration, path balancing, error policies handling for port error issues such as loss of sync or CRC violations.

Device manager 414 handles error policies such as device level errors, for example, command retry errors, media command errors, and port errors.

Configuration manager 416 handles volume policies, such as, for example, volume caching, pre-fetch, LUN permissions, and RAID policies, including reading mirrors and alternate device recovery.

Enclosure manager 418 handles hardware system support elements, such as fan speed and power supply output voltages.

Background manager 420 provides ongoing support maintenance functionality to disk management including, for example, device health check, device scan, and the GUI data refresh rate.

Other manager 422 is representative of other managers that may be employed within RAID controllers 130. Other managers may be envisioned here by those skilled in the art, and the invention is not limited to use with only the managers described in FIG. 4.

With reference to FIGS. 2 through 4, the operation of RAID controllers 130 is described as follows:

Unique customer requirements for RAID network behavior and performance are entered into an interactive menu-driven GUI application (not shown) that runs on a general-purpose computer, such as, for example, a personal computer (PC) (not shown). These customer requirements include the attributes of system manager 228, as described in the discussion of FIG. 4 and include, but are not limited to, for example, volume and cache behavior; water marks for flushing cache; prefetch behavior, i.e., setting the number of blocks to prefetch; error recovery behavior, i.e., number of retry times; path balancing; fibre channel port behavior, i.e., number and type of time outs; and Buffet to Buffer (BB) time credits. As a result of this process, an XML computer file (not shown) is generated that contains a profile of RAID attributes described as “personality” data. A compact flash image is built for the XML personality data and is downloaded into a removable compact flash 325, via PC 210, after which it is installed into RAID controller hardware 250. At startup time, RAID controllers 130 are initialized and the XML personality data is loaded in accordance with step 514 of flow diagram of method 500, described below, which provides customization of software constructs within system manager 228. This customization provides RAID controllers 130 with a way for the behavior, or “personality,” of RAID controllers 130 to be customized, based on their intended application, as defined by the customer.

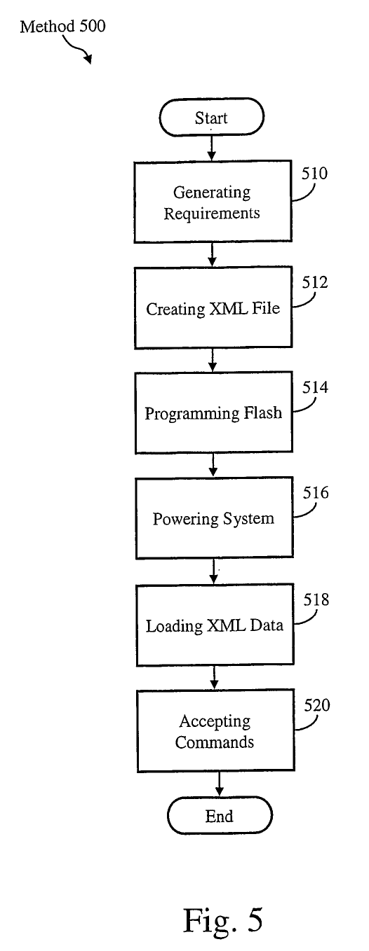

FIG. 5 illustrates a flow diagram of a method 500 of initializing RAID controllers 130 that have unique personality data. FIGS. 1 through 4 are referenced throughout the method steps of method 500. Further, it is noted that the use of method 500 of initializing a RAID controller is not limited to RAID controllers 130; method 500 may be used with any generalized controller system or application.

Method 500 includes the steps of:

Step 510: Generating Requirements

In this step, an OEM or other customer determines the RAID behaviors that are required for the specific application. This is a separate application that is run by the OEM, or other customer, that facilitates the enabling, disabling and range setting of each configurable personality. Behaviors include, but are not limited to volume and cache behavior; water marks for flushing cache; prefetch behavior, i.e., setting the number of blocks to prefetch; error recovery behavior, i.e., number of retry times; path balancing; fibre channel port behavior, i.e., number and type of time outs; and BB time credits. Method 500 proceeds to step 512.

Step 512: Creating XML File

In this step, unique customer requirements for RAID network behavior and performance, as defined in step 510, are entered into an interactive, menu-driven GUI 212 that is running on PC 210. As a result of this process, an XML computer file (not shown) is generated that contains a profile of RAID attributes described as “personality” data. Method 500 proceeds to step 514.

Step 514: Programming Flash

In this step, a compact flash image is built that contains the XML personality data and is programmed into a removable compact flash 325, by a standard industry flash programmer (not shown), after which it is installed into RAID controller hardware 250. Method 500 proceeds to step 516.

Step 516: Powering System

In this step, RAID controllers 130 are powered up. Method 500 proceeds to step 518.

Step 518: Loading XML Data

In this step, at startup time, CIMOM 222 that is running out of processor 220 reads the XML data contained within flash 225 of RAID controller hardware 250. CIMOM 222 transfers the XML data to SAL 224, where the XML data is converted to a binary data file. Controller manager 410 reads this binary data file and instantiates the controller classes and objects. After instantiation, controller manager 410 makes method calls, sets cache, and makes a parameter call to ATA controller 330 and RTP 340 to indicate that personality attribute data is available in cache. As a result, the objects and classes of port manager 412 (e.g., fibre channel port configuration, path balancing, and error policy for port issues) device manager 414 (e.g., device error handling, media errors, mode page policies, and device error statistics, for example), configuration manager 416 (e.g., volume policies, caching, pre-fetch, LUN permissions, and RAID policies alt device policies, for), enclosure manager 418 (e.g., enclosure maintenance, heat, and fans), and background manager 420 (e.g., SES poll time configurable from the customer, spare patrol, net logging), and configuring RAID controllers 130 are instantiated. The instantiated objects of RTP 340 provide a method call to initialize the operation of RTP 340. Method 500 proceeds to step 520.

Step 520: Accepting Commands

RAID controllers 130 are initialized and ready to accept host commands for normal operation. Method 500 ends.

Although the present invention has been described in relation to particular embodiments thereof, many other variations and modifications and other uses will become apparent to those skilled in the art. Therefore, the present invention is to be limited not by the specific disclosure herein, but only by the appended claims.

What is claimed is:

1. A method for providing application-specific configuration data for a network controller, comprising:
generating a plurality of user-specific network requirements;
programming a reprogrammable memory located in the network controller to contain the plurality of user-specific network requirements;
powering-up the network controller; and
loading the plurality of user-specific network requirements onto a plurality of software applications running on the network controller.

2. The method of claim 1, wherein the steps of generating and programming are performed by a network controller manufacturer.

3. The method of claim 1, wherein the step of programming further comprises:
storing the plurality of user-specific network requirements in a computer file; and
copying the computer file onto the reprogrammable memory.

4. The method of claim 3, wherein the computer file is an extensible markup language (XML) computer file.

5. The method of claim 4, wherein the step of loading further comprises converting the XML computer file to a binary data file that a plurality of hardware components in the network controller may use.

6. The method of claim 1, wherein the reprogrammable memory is a FLASH memory.

7. A system for providing application-specific configuration data for a network controller, comprising:
a network controller;
a reprogrammable memory located in the network controller configured to store a plurality of user-specific network requirements; and
a plurality of software applications running on the network controller onto which the plurality of user-specific network requirements may be loaded.

8. The system of claim 7, wherein the plurality of user-specific network requirements are stored on the reprogrammable memory by a network controller manufacturer.

9. The system of claim 7, wherein the reprogrammable memory stores the plurality of user-specific network requirements in an extensible markup language (XML) computer file.

10. The system of claim 9, wherein the network controller is configured to convert the XML computer file to a binary data file that a plurality of hardware components in the network controller may use.

11. The system of claim 7, wherein the reprogrammable memory is a FLASH memory.
